(19) United States
(12) Patent Application Publication
(10) Pub. No.: US 2024/0034692 A1
(43) Pub. Date: Feb. 1, 2024

(54) Plasterboard with Improved Nail Pull Resistance

(71) Applicant: Knauf Gips KG, Iphofen (DE)

(72) Inventors: Stergios Karakoussis, Laubach (DE); Georgi Paraskov, Neustadt an der Aisch (DE); Alexander Hartmann, Kleinlangheim (DE); Carlo Knauf, Weigenheim (DE); Anton Peter, Wuerzburg (DE)

(73) Assignee: Knauf Gips KG, Iphofen (DE)

(21) Appl. No.: 18/268,739

(22) PCT Filed: Dec. 22, 2021
(86) PCT No.: PCT/EP2021/000158

§ 371 Date: Jun. 21, 2023

(30) Foreign Application Priority Data
Dec. 22, 2020 (EP) 20000482.8

(51) Int. Cl. C04B 41/50; C04B 28/14; C04B 38/10

(52) U.S. Cl. CPC C04B 41/5076; C04B 28/14; C04B 38/106; C04B 2103/40

(57) ABSTRACT

The present invention is concerned with plasterboards including at least two layers A and B of different composition, wherein layer A includes a calcium sulfate binder and a synthetic polymer foam and the layer B includes a calcium sulfate binder and a surfactant foam and wherein the at least one layer A is a surface layer. Improved nail pull resistance can be achieved in lightweight plasterboards, if foamed synthetic polymer is present in a surface layer. The present invention further concerns a method for the production of corresponding products, an apparatus for the production of such products as well as the use of synthetic polymer foam in a surface layer to produce plasterboards with high nail pull resistance at a minimal amount of synthetic polymer.

### CROSS-REFERENCE TO RELATED APPLICATIONS

This application is the United States national phase of International Application No. PCT/EP2021/000158 filed Dec. 22, 2021, and claims priority to European Patent Application No. 20000482.8 filed Dec. 22, 2020, the disclosures of which are hereby incorporated by reference in their entireties.

### BACKGROUND OF THE INVENTION

### Field of the Invention

The present invention is concerned with multilayer plasterboards having enhanced nail pull resistance even in lightweight boards. The present invention is further concerned with methods for the production of corresponding products, an apparatus for the production of such products as well as the use of a synthetic polymer foam for the production of plasterboards with high nail pull resistance.

### Description of Related Art

In a conventional plasterboard production, a calcium sulfate slurry is usually produced using a high-speed rotary mixer. The mixed slurry is subsequently discharged onto a paper or fibrous liner material via a discharging device. The calcium sulfate slurry regularly comprises calcium sulfate as stucco (hemihydrate with possibly minor amounts of anhydrite and/or dihydrate), water, additives and optionally (surfactant) foam.

The additives are auxiliaries, such as liquefiers, accelerators or retarders, which adapt or control the properties of the slurry according to production conditions and modify the plasterboard properties.

The foam additive is the key functional ingredient to control the density of gypsum boards by forming voids. Foam with the desired properties is regularly produced in advance in an appropriate foam generator. The pre-generated foam is then added to the slurry in the mixer along with the other components or it is added to the slurry downstream of the mixer prior to the slurry discharge. To produce the foam, surfactants are typically mixed with water and compressed air is added under high shear. The surfactant ensures that the air is entrapped in sufficiently stable foam bubbles via a surfactant film and the formation of micelles. Depending on the type of surfactant and concentration of the mixture, foams can have varying densities, whereby densities of 70 g/L-250 g/L are preferred for plasterboard production. Typically, plasterboards with final densities in the range of 350-1200 kg/m³ can be produced with surfactant-based foams.

While the incorporation of foam reduces the weight of boards, this is regularly at the cost of a decline in other desired properties of the gypsum board. Most notably, the voids in the board have a negative impact on properties such as surface hardness, compressive strength, nail pull resistance and screwability of the board. Insufficient screwability is a reason for customer complaints. If the plasterboard is not sufficiently hard and stable, screws can easily be driven in too deeply or pull through during or after fixation of the plasterboard to the framing. Nail pull resistance measurements quantify this property.

To counteract these detrimental effects, it is possible to incorporate further chemicals in the board composition, which may again improve the surface hardness and/or the stability and the nail pull. However, depending on the targeted volume weight, these additives have to be used in relatively high amounts and thus frequently increase the cost of the board.

Alternatively, boards can be manufactured with a lightweight core and outer layers that have a higher density, adding unnecessary weight to the board.

Based on this assessment, there is a need for lightweight plasterboards with the desired improved strength and nail pull resistance, but with lower absolute costs.

### SUMMARY OF THE INVENTION

In the investigations underlying this invention, it has been found that a plasterboard comprising at least two layers A and B of different composition, wherein layer A comprises a calcium sulfate binder and a synthetic polymer foam and the layer B comprises a calcium sulfate binder and optionally a surfactant foam and wherein the at least one layer A is a surface layer that addresses these needs.

The term “plasterboard”, also known as drywall panel or wallboard, according to this invention refers to flat sheets used in construction to assemble walls, floors or ceilings. Plasterboards generally comprise 70-98 wt. % gypsum, i.e. calcium sulfate dihydrate, based on the total weight of the board. A plasterboard is produced by mixing a calcium sulfate binder, i.e. a calcium sulfate hemihydrate (comprising mainly CaSO₄×½ H₂O) with water and optionally foam and other additives to form a calcium sulfate slurry. After being mixed with water, and optionally foam and other additives, the calcium sulfate binder incorporates water in its crystalline structure and forms gypsum (calcium sulfate dihydrate, CaSO₄×2 H₂O). In addition to hemihydrate, the calcium sulfate binder regularly contains minor amounts of calcium sulfate anhydrite (CaSO₄) and calcium sulfate dihydrate (CaSO₄×2 H₂O), as well as other impurities. This calcium sulfate binder blend is called stucco. In a finished plasterboard according to the invention, the calcium sulfate in both layers A and B is predominantly present as calcium sulfate dihydrate.

The plasterboard can comprise at least 45 wt.-%, preferably 60 to 99 wt.-%, more preferably 70 to 98 wt.-% and most preferably 80 to 98 wt.-% calcium sulfate dihydrate based on the total weight of the plasterboard. For the production of the plasterboard, alpha- or beta calcium sulfate hemihydrate are suitable, whereas beta hemihydrate is preferred.

If foam is used in both layers A and B of the plasterboard, the overall weight of the plasterboard can be adjusted in a wide range. With foam, plasterboards with densities of 450 kg/m³, preferably 350 kg/m³, and lower can be achieved.

By specifying that at least one layer A is a surface layer is meant to denote that at least one layer A forms an outermost calcium sulfate based layer in the plasterboard relative to other calcium sulfate based layers in the product, i.e. at least one layer A may only be further covered by a non-gypsum layer such as a liner.

With regard to the invention, it has unexpectedly been found that plasterboards with at least two layers A and B of a different composition can be prepared, wherein the individual layers strongly adhere to each other and there is no incompatibility of the two. In addition, it has been found that it is effective to concentrate and limit the synthetic polymer foam to the region that is subjected to most external stresses. By limiting the synthetic polymer foam to a surface layer A, external stresses can be absorbed mainly by the outermost part/s of the board. Also, the nail pull resistance can be improved. Thus, by protecting the outermost part/s of the board, a less stress resistant material can be used for the remaining board, thereby limiting the impact on the physical properties, such as the nail pull resistance, of the board.

The synthetic polymer to be used for the production of the synthetic polymer foam in the practice of the present invention is not subject to any relevant restrictions except that the synthetic polymer has to be capable of providing a foam in an aqueous environment upon being admixed with a gas. A synthetic polymer foam can comprise more than 90 wt.-%, preferably more than 95 wt. %, most preferably more than 99 wt.-% synthetic polymers based on all foam forming components aside from water or gas. Particularly suitable synthetic polymers for foam production comprise vinyl acrylic copolymers, polyvinyl acetate, polyvinyl alcohol and/or melamine formaldehyde or mixtures thereof, of which polyvinyl acetate and/or polyvinyl alcohol are preferred.

The amount of the synthetic polymer should on the one hand be thus, that sufficient foam can be produced to adjust the density of the layer A to the desired range, but on the other hand, for cost reasons, the amount of the synthetic polymer should not be more than necessary for this purpose. A suitable amount of a synthetic polymer based on its solids content, relative to the calcium sulfate binder is for example, 0.2 to 5 wt.-%, preferably 0.4 to 3.5 wt.-%, most preferably 0.5 to 2.0 wt.-%.

With regard to the above layer A, it is noted that the main foam forming component therein is the synthetic polymer, so that further foam forming components, such as surfactants are usually not necessary. Preferably, the synthetic polymer is the only foam forming ingredient in layer A and/or layer A is not formulated with a surfactant foam. However, the presence of surfactants in the layer A is not strictly excluded and it is possible that minor amounts thereof are incorporated.

The wording “formulated” in the context of this invention means that the respective ingredient is purposefully added to a composition, which may be used to form a product. In other words, if a composition is not formulated with an ingredient, this only excludes that this ingredient is added intentionally, but does not exclude the presence of trace amounts of this ingredient, which may be contained as impurity of other constituents, which are used to formulate that composition.

In the inventive plasterboards, the thickness of the layer A will regularly be adjusted such, that the intended purpose of increasing the surface strength is achieved best. In most cases, for that purpose it is sufficient that the layer A makes up 40% or less of the thickness of the plasterboard excluding optionally present liners, preferably the layer A makes up 5% to 40% of the thickness of the plasterboard excluding any liners.

In addition, it has been found that the density of the layers A and B does not need to be identical and can vary to some extent, without increasing the risk for deformations of the plasterboard during the drying process. In a preferred embodiment, thus, the density of the layers A and B differs by at most 100 kg/m³. More preferably, the density differs by at most 50 kg/m³. Most preferably, the density differs by at most 10 kg/m³.

Alternatively or in addition thereto, it is preferred that the layer A has a density of 350 to 1200 kg/m³, preferably 350 to 700 kg/m³ and/or the layer B has a density of 350 to 1200 kg/m³, preferably 350 to 700 kg/m³. Further preferably, both layers A and B have a density in the range of 350 to 700 kg/m³, even more preferably both layers A and B have approximately the same density, whereby the same density is desired and the word “approximately” seeks to cover any imprecision attributable to the production process.

In the dry state, layer A of the inventive plasterboard is primarily constituted of gypsum, followed by synthetic polymer, and optional additives and is conventionally prepared from stucco, water, synthetic polymer foam and optional additives. Similarly, in the dry state, layer B of this plasterboard is primarily constituted gypsum, followed by a surfactant and optional additives and is conventionally prepared from a stucco, water, a surfactant foam and optional additives. In a preferred embodiment, layer A contains less surfactant foam than the layer B, preferably the layer A does not contain a surfactant foam.

Suitable surfactants for use in the preparation of the surfactant foam in the layer B include e.g. alkali metal and/or ammonium salts of ethoxylated, sulfated alcohols as foaming agents such as those described in U.S. Pat. No. 5,683,635 B. To prepare the foam, the surfactant is admixed with water, wherein the water accounts for the major part of the mixture. For example, the weight ratio of water to soap or surfactant in such mixtures is regularly at least 5:1, preferably at least 9:1 and more preferably at least 15:1. A surfactant foam can comprise at least 60 wt. %, preferably at least 90 wt. %, most preferably more than 98 wt. % surfactant based on all foam forming components aside from water, or other liquids or gas.

The gas in the respective foams can be regular air, but can also be inert gases such as nitrogen, carbon dioxide or argon.

Further additives, which are conventionally used in the production of plasterboards may be added to the compositions used to prepare layer A and/or layer B to adjust or optimize one or more workability properties and final characteristics thereof. For example, an accelerator can be added to speed up the setting of the respective layers, a retardant can be added to delay the setting, and a liquefier/dispersant can be added to improve the flowing and processing properties of the respective composition. Moreover, it is possible to incorporate fibers and in particular glass fibers to improve the strength, dispersing agents to aid in dispersing the dry materials into the aqueous slurry or paper bonding agents and strength enhancers such as e.g. starch. In addition, agents to enhance water resistance of the set gypsum, fillers or fire-resistant additives such as clay, colloidal alumina, muscovite, vermiculite, aluminium hydroxide or water-insoluble calcium sulfate anhydrite whisker fibers can be incorporated. Appropriate additives are well known and available to the skilled practitioner. Accordingly, the layers A and/or B in the inventive plasterboard can comprise one or more of the listed additives.

Although the present description of the inventive plasterboard focused on a board with only one layer A and one layer B, three as well as more than three layers are also encompassed by this invention. In a three-layered board, two layers A can be opposing surface layers. In a board with more than three layers, at least one layer A is not a surface layer. If an inventive plasterboard is used for mounting to e.g. a wall structure, at least one layer A of the plasterboard faces the interior of a room.

Plasterboards generally further comprise a liner or facer covering the surfaces of the board, preferably also covering at least two edges. In plasterboards with liners, the liner is typically the outmost and thus visible component of the board. Consequently, only non-covered edges can expose the gypsum layers in these plasterboards. Preferably, the liner is a paper liner or a fiber mat (e.g. scrim, woven, or non-woven). The fiber mat can be made of glass fibers or a mixture of synthetic, glass/mineral and/or cellulosic fibers. To strengthen and enforce the board, a paper liner with a high grammage (>200 g/m² and preferably >220 g/m²) is preferred.

The inventive plasterboard preferably has a nail pull resistance of at least 240 N, more preferably at least 250 N and even more preferably at least 270 N. A possible upper limit of the nail pull resistance could be 500 N, preferably 400 N, depending on the overall structure of the product. For the purposes of this invention, the nail pull resistance is determined by ASTM C473:2010.

In a further aspect, the invention is concerned with a wall structure, which comprises at least one plasterboard as described above, wherein the plasterboard is mounted to at least one stud and wherein the plasterboard is positioned within the wall structure such that at least one layer A of the plasterboard faces the interior of a room. This ensures that e.g. a screw head contacts layer A in the mounted state.

### BRIEF DESCRIPTION OF THE DRAWINGS

In the following, the invention will be illustrated in detail by aid of non-limiting, exemplary embodiments in FIGS. 1 to 4. These examples should not be construed as limiting the scope of the invention in any respect.

FIG. 1: Embodiment for the production of a two-layered plasterboard comprising the use of two foaming devices and two mixers.

FIG. 2: Embodiment for the production of a two-layered plasterboard comprising the use of two foaming devices and one mixer.

FIG. 3: Embodiment for the production of a three-layered plasterboard comprising the use of two foaming devices and two mixers.

FIG. 4: Embodiment for the production of a three-layered plasterboard comprising the use of two foaming devices and one mixer.

FIG. 5: Nail pull measurements of test specimen comprising surfactant foam and test specimen comprising synthetic polymer foam.

### DESCRIPTION OF THE INVENTION

In a further aspect, the invention is concerned with a method for the production of a plasterboard, preferably a plasterboard as described above, comprising the steps:
(i) preparing a synthetic polymer foam in a first foaming device and preparing a surfactant foam in a second foaming device,
(ii) preparing a calcium sulfate mixture comprising stucco, water and optional additives in a mixer 3, 4,
(iii) admixing the synthetic polymer foam to a part of the mixture prepared in the mixer 3, 4 to form a first slurry for layer A,
(iv) admixing the surfactant foam to another part of the mixture prepared in a mixer 4 to form a second slurry for layer B,
(v) depositing the first slurry from a first discharging device 5, 5a, 50, 50a onto a substrate to provide a layer A,
(vi) and depositing the second slurry from a second discharging device 6 onto the first slurry to provide a layer B,

The substrate in in step (v) can be a liner.

In addition thereto, part of the surfactant foam in step (iii) can be admixed to the mixture to form the first slurry for the layer A. Preferably, the surfactant foam admixed to the first slurry for layer A is smaller than the amount of surfactant foam admixed to the second slurry for layer B. More preferably, the amount of surfactant foam is quantified as 0.01 to 1.0 wt.-% active ingredients, relative to the calcium sulfate binder.

In most cases, the first slurry will be used to form a surface layer (A) and could thus be considered a surface slurry. Similarly, the second slurry will generally be used to produce a core layer (B) and could thus be considered a core slurry. The core layer is considered a core because it generally has the largest thickness (as well as the largest volume), irrespective of whether it is covered by only one or two surface layers.

In this method, the synthetic polymer foam in step (i) preferably has a density of 70 to 250 g/L, more preferably of 100 to 200 g/L.

In a yet further aspect, the invention concerns an apparatus, preferably for implementing a method as described above, wherein said apparatus has the means to apply two mixtures of different composition onto a moving substrate such that one of the mixtures is applied onto the substrate first and the other mixture is subsequently applied onto the first mixture to form a two layered product having at least one surface layer A and a core layer B. The corresponding apparatus comprises a first foaming device 1 for producing a synthetic polymer foam and a second foaming device 2 for producing a surfactant foam. It further comprises at least one mixer 3, 4 for producing a mixture comprising at least stucco and water. The synthetic polymer foam is admixed to the mixture of mixer 3, 4 to form a first slurry and the surfactant foam is admixed to the mixture of mixer 4 to form a second slurry and optionally the first slurry is supplemented with surfactant foam. The apparatus further comprises a first discharging device 5, 5a, 50, 50a for dispensing the first slurry onto a substrate, preferably onto a liner. It also comprises a second discharging device 6 for dispensing the second slurry onto the first slurry. The first foaming device 1 of this apparatus is fluidly interconnected to the first discharging device 5, 5a, 50, 50a, and the second foaming device 2 is fluidly interconnected to the second discharging device 6, optionally the second foaming device is further fluidly interconnected to the first discharging device. Furthermore, the first discharging device 5, 5a, 50, 50a and the second discharging device 6 are spaced apart spatially such that the first slurry from the first discharging device 5, 5a, 50, 50a comprising a synthetic polymer foam 15, 15a is dispensed upstream of the second slurry of the second discharging device 6 comprising the surfactant foam 16.

The term “fluidly interconnected” denotes that a fluid, such as for example a foam, is able to flow from one component to another, but the two components are not necessarily adjacent and/or need not be directly connected to one another. Instead, they may be separated by other components. For example, a conduit (or duct) and/or a first mixer can be situated between the first foaming device and the first discharge device, if these two are fluidly interconnected. Alternatively, or in addition thereto, a conduit (or duct) and/or a second mixer can be situated between the second foaming device and the second mixer. More explicitly, this means that a synthetic polymer foam is created in a first foaming device. From there it travels to a first discharging device via a conduit or it travels to a first discharging device via a conduit and a first mixer. If the synthetic polymer foam does not travel via a first mixer, it is mixed with a slurry received from a second mixer. This mixing can occur in the first discharge device. Alternatively, it could also circumvent a first mixer and be mixed with the slurry of the first mixer in the discharge device. In all alternatives, the first foaming device is fluidly interconnected to the first discharging device. Similarly, the surfactant foam that is created in the second foaming device can travel from there to a second discharge device via a conduit or via a conduit and a second mixer. If the surfactant foam does not enter a mixer, the mixing of the surfactant foam with a slurry can take place in the second discharge device. Again, the second foaming device is fluidly interconnected to the second discharging device in both alternatives. The term “directly connected” denotes that the two components are adjacent to one another. It further denotes that the two components may only be separated by minor components that are not explicitly mentioned in this disclosure such as e.g. connecting pieces, valves etc.

A typical plasterboard manufacture involves mixing the solid components including calcium sulfate hemihydrate (stucco) with water in a mixer to form a slurry. Liquid additives are generally introduced into this mixer. Foam can be introduced into the mixer or after leaving the mixer, sometimes even both in the mixer and after leaving the mixer. As the action of a mixer can destroy some of the foam, foam is frequently incorporated downstream of the mixer.

A plasterboard according to the invention can be two-layered, three-layered or comprise more than three layers. Apparatus embodiments for two- and three-layered plasterboards are presented.

In a preferred embodiment, the first foaming device 1 of the apparatus described above is fluidly interconnected to the first discharging device 5, 5a via a first mixer 3 and/or the second foaming device is fluidly interconnected to the second discharging device via a second mixer 4. Alternatively, or in addition thereto, the first foaming device 1 can be connected directly to the first discharging device 50, 50a and/or the second foaming device can be connected directly to the second discharging device. Foam can be added to the slurry in a mixer or admixed in one of the discharging devices. If foam is added to the slurry in a discharging device, the discharging device generally comprises a device or structure that will promote the mixing of the foam with the slurry.

Preferably, at least one of the foaming devices 1 and 2 is a stick mixer.

Further, it is possible that the inventive apparatus can have a levelling means such as a rotating roll 8, by which the thickness of a first slurry 15, 15a for layer A on a substrate, can be spread and adjusted before the second slurry 16 for layer B is applied onto the layer A 15 or the layer A 15a is applied onto the second slurry 16.

After the plasterboard ribbon has been formed and separated into individual boards, the boards are dried in a dryer (not shown).

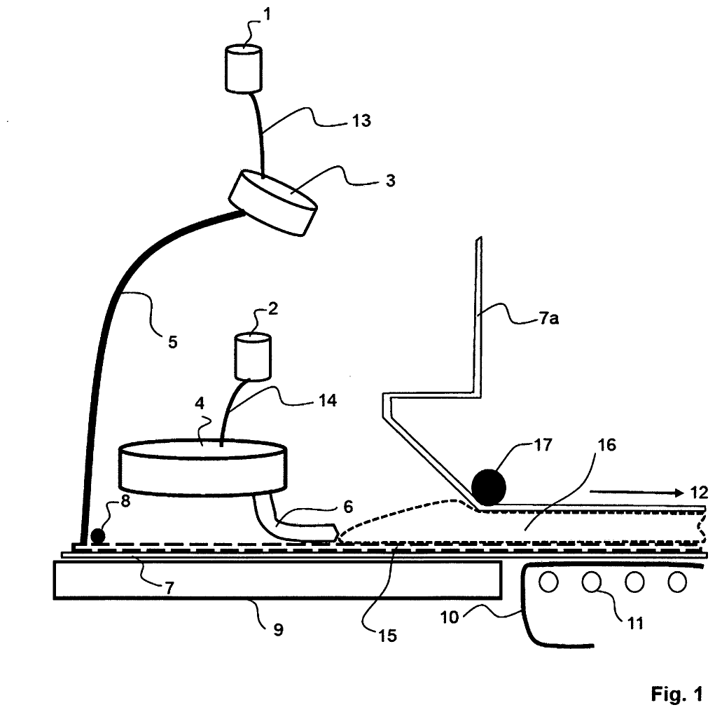

In the following, the inventive apparatus and process will be illustrated in more detail with reference to FIG. 1, which illustrates an exemplary embodiment of the inventive apparatus. In FIG. 1, the first foaming device 1 (e.g. a stick mixer) is supplied with a synthetic polymer material (e.g. polyvinyl acetate with a density of about 1100 g/L) to generate a respective foam (synthetic polymer foam) with a density of about 100 to 200 g/L. This foam is the introduced into a first mixer 3 via a first conduit 13. The first mixer 3 comprises additional conduits for adding water, stucco and additives (not shown), e.g. conduit(s) for adding liquid and a conduit(s) for adding solid ingredients. Additives can comprise accelerators, liquefiers, and fibers (e.g. glass or cellulose fibers). In the first mixer 3, a first calcium sulfate mixture (slurry) is generated, which is then discharged via the first discharging device 5 onto a moving substrate 7 (e.g. paper, woven or non-woven liner) on a conveyor 9. After depositing the slurry, a rotating roller 8, typically a reverse roller, adjusts the height of the applied slurry, usually by picking up a thin layer of slurry before depositing it on the liner, to form e.g. a layer A of the plasterboard.

The apparatus in FIG. 1 has a further foaming device 2, which is supplied with a surfactant and water to generate a second foam (surfactant foam) with a density of e.g. 60 to 200 g/L. This foam is introduced into a second mixer 4 via a second conduit 14. The second mixer 4 comprises additional conduits for adding water, stucco and additives (not shown), e.g. conduit(s) for adding all liquid and conduit(s) for adding all solid ingredients. The generated mixture (a slurry) is then deposited onto layer A (formed from the first slurry) via the discharge device 6 to form layer B. Thereafter, layer B is covered by a liner 7a. Rotating roller 17 is a guide roller for the liner, which is also responsible for the shaping and/or height adjustment of the slurry (particularly for layer B), but without direct contact to the slurry (here layer B). The setting calcium sulfate material is conveyed by means of a setting belt 10 and a roller conveyor 11 to a cutting device and finally a dryer (not shown). The direction of travel is depicted by an arrow 12. Optionally, part of the surfactant foam is additionally introduced into the first mixer 3 or first discharging device 5 (conduit not shown).

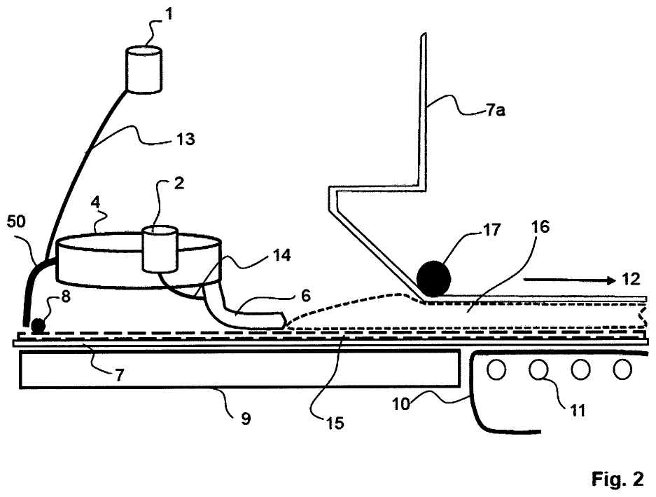

FIG. 2 depicts an alternative embodiment with only one mixer 4. The mixer comprises conduits for adding water, stucco and additives (not shown). After mixing the components, the mixture (slurry) is discharged via the first 50 and second discharging device 6. Again, the first foaming device 1 (e.g. a stick mixer) is supplied with a synthetic polymer material (e.g. polyvinyl acetate with a density of about 1100 g/L) to generate a respective foam with a density of about 100 to 200 g/L. This foam is not introduced into mixer 4, but instead directly into the first discharging device 50 via a first conduit 13. From there the mixture is discharged onto a moving substrate 7 (e.g. paper liner). After depositing the mixture, a rotating roll 8 spreads the applied mixture over the intended width. The apparatus has a second foaming device 2, which is supplied with a surfactant and water to generate a second foam (surfactant foam) with a density of e.g. 60 to 200 g/L. This surfactant foam is introduced into the second discharging device 6 via a second conduit 14. Additives, rollers 8, 17 as well conveyor 9, setting belt 10, roller conveyor 11 and dryer (not shown) serve the same purpose as described in FIG. 1. Optionally, part of the surfactant foam can additionally be introduced into the first discharging device 50 (conduit not shown)

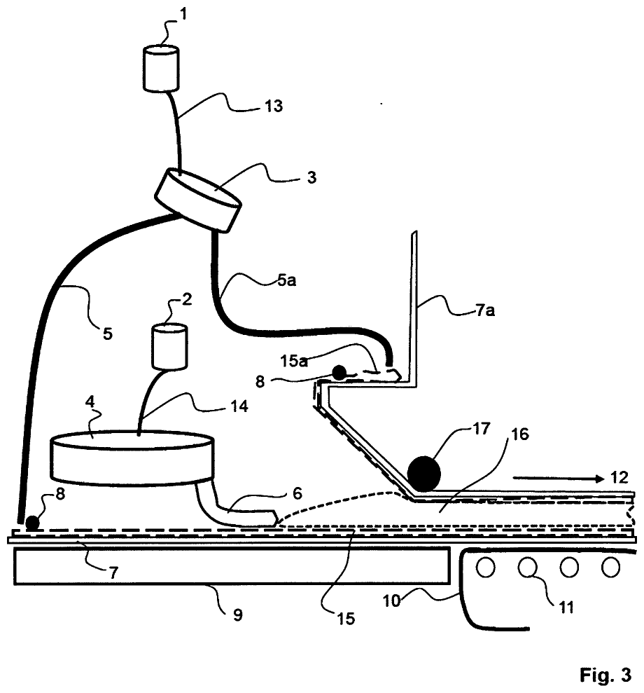

FIG. 3 shows and embodiment for a three-layered plasterboard produced with two mixers 3 and 4. Both mixers 3 and 4 comprise conduits for adding water, stucco and additives (not shown). The synthetic polymer foam created in the first foaming device 1 is added to the mixture in mixer 3 via a first conduit 13. After mixing the components, the mixture (slurry) of mixer 3 is discharged via two first discharging devices 5 and 5a onto the moving substrates 7 and 7a (e.g. upper and lower liner). The first discharging device 5 is positioned upstream of the second discharging device 6. The surfactant foam created in the second foaming device 2 is added to the mixture in mixer 4 via a second conduit 14. After mixing the components, the mixture (slurry) of mixer 4 is discharged via the second discharging device 6 onto a moving substrate, in this case the previously applied slurry comprising a synthetic polymer foam 15 creating layer A of the plasterboard. The moving web and substrate (liner) 7a and first discharging device 5a are positioned such, that the substrate 7a along with the slurry of mixer 3 joins the mixture (slurry for layer B of the plasterboard) of mixer 4 from above such that the slurries bond. Additives, rollers 8, 17 as well conveyor 9, setting belt 10, roller conveyor 11 and dryer (not shown) serve the same purpose as described in FIG. 1. Optionally, part of the surfactant foam can additionally be introduced into the first mixer 3 or first discharging device 5, 5a (conduit not shown).

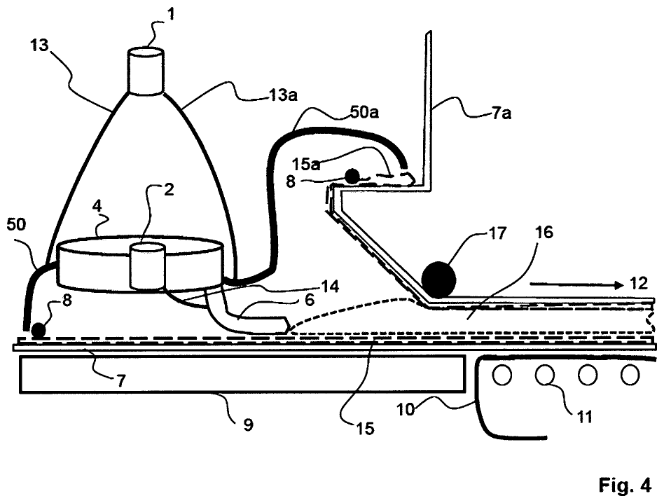

FIG. 4 depicts an embodiment for producing a three-layered plasterboard using one mixer. Mixer 4 comprises conduits for adding water, stucco and additives (not shown). A synthetic polymer foam is produced in a first foaming device 1 and a surfactant foam is produced in a second foaming device 2. After mixing the components, the mixture (slurry) of mixer 4 is discharged via two first discharging devices 50, 50a and a second discharging device 6. The synthetic polymer foam travels from the first foaming device 1 to the first discharging devices 50, 50a via first conduits 13, 13a. The surfactant foam travels from the second foaming device 2 to the second discharging device 6 via a second conduit 14. The first discharging devices 50, 50a discharge slurry onto a moving substrate 7 and 7a, respectively, i.e. the liners of the plasterboard. The second discharging device 6 is positioned downstream of first discharging device 50 and discharges slurry onto a substrate comprising the previously applied slurry forming the first layer A. The moving web and substrate 7a and first discharging device 50a are positioned such, that the substrate 7a along with the slurry of from the first discharging device 50a join the slurry from the second discharging device 6 from above such that the slurries bond. Additives, rollers 8, 17 as well conveyor 9, setting belt 10, roller conveyor 11 and dryer (not shown) serve the same purpose as described for FIG. 1. Optionally, part of the surfactant foam can additionally be introduced into the first discharging device 50, 50a (conduit not shown).

Various combinations of individual features of the embodiments described in the figures are also possible. For example, part of the synthetic polymer foam can enter a mixer 3 and the other part can be introduced into the first discharging device 5, 5a. Similarly, part of the surfactant foam can be introduced into a mixer 4, while the other part of the surfactant foam can be introduced into the second discharging device 6.

In yet another not explicitly depicted combination, the synthetic polymer foam can be produced in the first foaming device 1, guided to the first mixer 3 via a first conduit 13 and exit the first mixer 3 into a first discharging device. At the same time, the surfactant foam can be routed from the second foaming device 2 to the second conduit 14 and directly to the second discharging device 6, without entering the second mixer. Vice versa, the synthetic polymer foam can circumvent the first mixer 3 and be guided directly to the first discharging device 5, 5a, while the surfactant foam or at least part of the surfactant foam enters the second mixer 4 before exiting into the second discharging device 6. If, as e.g. in FIG. 2 or 4, only one mixer is present and surfactant foam can be added to the slurry in the mixer 4, then an agitator (not shown) can be interjected between the first mixer 4 and the first discharging device 5, 50, 50a to disintegrate the surfactant foam. Synthetic polymer foam can then be added to the first discharging device 5, 50, downstream of the agitator. In all alternatives, the first foaming device 1 of an inventive apparatus is fluidly interconnected (only) to the first discharging device.

In a final aspect, the invention concerns the use of a synthetic polymer foam for the preparation of at least one surface layer A of a plasterboard to obtain a nail pull resistance of at least 240 N, as determined by ASTM C473:2010. Preferably, the synthetic polymer foam is not used in layer B.

In the above, any preferred or particularly suitable embodiments, which have been described in connection with one aspect, are also applicable to all other aspects of the invention, unless that combination is in clear contradiction to that aspect. Thus, all such combinations are encompassed by and deemed as described in invention, even if this is not explicitly indicated.

### EXAMPLES

### Example 1: Investigation of the Effect of Surfactant and Synthetic Polymer Foams on the Physical Characteristics of Gypsum Boards

Test prisms with dimensions of 4×4×16 cm, were produced by formulating and mixing the compositions as shown in Table 1, pouring them into respective molds and allowing them to set and drying them to a constant weight. The respective characteristics of flexural strength, compressive strength and surface hardness were assessed according to DIN EN 13279-2:2004.

TABLE 1

| | | | | Sample 4 |
|---|---|---|---|---|
| | | Sample 2 | Sample 3 | With 1.85 wt.-% |
| | | With | With 1.85 wt.-% | synthetic |
| | Sample 1 | surfactant foam | synthetic | polymer¹ |
| | Without | (foamed to a | polymer¹ | (foamed to a |
| | additive | density of 70 g/L) | (unfoamed) | density of 180 g/L) |
| Stucco [g] | 740 | 740 | 740 | 740 |
| Water [g] | 440 | 440 | 416.7 | 416.7 |
| Synthetic | 0 | 0 | 37 | 37 |
| polymer | | | | |
| emulsion [g] | | | | |
| Surfactant [g]³ | 0 | 18 | 0 | 0 |

Characteristics

| | | | | |
|---|---|---|---|---|
| Volumetric | 1167 | 869 | 1144 | 1022 |
| weight [kg/m³] | | | | |
| Flexural | 3.46 | 2.68 | 4.04 | 3.94 |
| strength⁴ | | | | |
| [N/mm²] | | | | |
| Compressive | 14.18 | 5.32 | 10.7 | 12.9 |
| strength⁴ | | | | |
| [N/mm]] | | | | |
| Surface | 25.1 | 9.3 | 16.6 | 18.2 |
| hardness⁴ | | | | |
| [N/mm²] | | | | |

¹=synthetic polymer solid matter based on the weight of the stucco;
² = the synthetic polymer emulsion has a solids content of 37%, with the remaining 63% being water; by adding the water content of the emulsion to the total water content, all samples were prepared with 440 g water;
³= the surfactant in Sample 2 contained 35% active ingredients;
⁴= determined according to DIN EN 13279-2: 2004

As is apparent from the above table, a compact plasterboard has the best surface hardness and compressive strength, but also the highest volumetric weight (Sample 1). If the product is formulated with a foam, the volumetric weight can significantly be reduced, but this is at the expense of a significantly decline in physical characteristics (Sample 2). Incorporating a synthetic polymer (Sample 3) provides a similar volumetric weight and improves the flexural strength, while ensuring a compressive strength and surface hardness that lie in between those of Samples 1 and 2. If the synthetic polymer is foamed, the flexural strength is not significantly affected, while the volumetric weight can be reduced significantly. Surprisingly, the compressive strength and surface hardness of Sample 4 are equivalent or even somewhat higher to those of Sample 3 with the same amount of non-foamed synthetic polymer.

### Example 2: Assessment of the Nail Pull Resistance of Test Boards Prepared with Foams from Synthetic Polymer and Surfactants

Table 2 below shows the composition of plasterboard test samples (12.5 mm×40 cm×30 cm):

TABLE 2

| | Sample 5 | Sample 6 | Sample 7 |
|---|---|---|---|
| | Surfactant | Synthetic polymer | Synthetic polymer |
| | foam (foamed | foam (foamed | foam (foamed |
| | to a density | to a density | to a density |
| | of 113 g/L) | of 180 g/L) | of 120 g/L) |
| Stucco [kg] | 14 | 14 | 14 |
| Water [L] | 9.9 | 9.9 | 9.9 |
| W/S ratio¹ | 0.71 | 0.71 | 0.71 |
| Accelerator [kg] | 0.02 | 0.02 | 0.02 |
| Liquefier [kg] | 0.06 | 0.06 | 0.06 |
| Volume of added | 12.35 | 12.89 | 12.35 |
| foam [L] | | | |
| Surfactant [ml]² | 35 | 0 | 0 |
| PVAc | 0 | 0.223 | 0.577 |
| emulsion [kg]³ | | | |

¹= water-to-stucco-ratio;
²= 35% active ingredients;
³= 37% solids content

The plasterboard test boards were covered by two non-woven fiber mat liners instead of the typically used high grammage paper liners. The thus prepared test boards were subjected to the nail pull test according to ASTM C473 (2010). The nail pull test is a measure of the force required to pull a plasterboard off a wall by forcing a fastening nail through the panel. The reported value for Nail Pull Resistance is the maximum stress achieved while the head penetrates through the board surface and core. The characteristics of the test samples and results of these investigations, which included three measurements each, are shown in Table 3 below:

TABLE 3

| | | Sample 6 | Sample 7 |
|---|---|---|---|
| | | Synthetic polymer | Synthetic polymer |
| | Sample 5 | foam (foamed | foam (foamed |
| | Surfactant | to a density | to a density |
| | foam | of 180 g/L) | of 120 g/L) |
| Thickness of test | 14.2 | 13.8 | 13.9 |
| board [mm] | | | |
| Volumetric weight | 586 | 574 | 580 |
| [kg/m³] | | | |
| wt.-% of surfactant | 0.09 wt.-% | 0.67 wt.-% | 1.51 wt.-% |
| active ingredients/ | | | |
| wt.-% of synthetic | | | |
| polymer solid matter | | | |
| based on weight of | | | |
| stucco | | | |
| Nail pull [N] | 234 ± 17 | 257 ± 11 | 294 ± 28 |

As is apparent from Table 3, the boards prepared with synthetic polymer instead of surfactant foam had about the same dry weight. However, the boards prepared using a synthetic polymer foam showed a significantly higher nail pull resistance. An increase in the amount of synthetic polymer from about 0.7 wt.-% to about 1.5 wt.-% of synthetic polymer solid matter based on the weight of the stucco further improved the nail pull resistance.

The results in both Examples 1 and 2 show that a synthetic polymer foam plasterboard has improved nail pull resistance relative to plasterboards prepared with surfactant foams. If the synthetic polymer foam based gypsum composition is used to prepare only the surface layer of a gypsum board, the amount of synthetic polymer necessary to prepare corresponding boards can be significantly decreased (e.g. to 30%, if the thickness of the synthetic polymer foam based gypsum layer is about 30% of the whole thickness of the board), without significant loss in the nail pull resistance performance.

### Example 3: Assessment of the Nail Pull Resistance of Test Specimen Prepared with Foams from a Synthetic Polymer, Surfactants or Both

Further nail pull resistance measurements according to ASTM C473:2010 were carried out for 20 cm×20 cm×1.2 cm test specimen. The results are shown in Tables 5 to 7. Analogous to Samples 5 to 7, these plasterboard test specimen were covered by two non-woven fiber mat liners instead of the typically used high grammage paper liners. Samples 8 and also layers B (8 mm to 10 mm thick) of Samples 10 were production castings. The stucco slurry containing the synthetic polymer foam was prepared analogously on the laboratory scale. Different volumetric weights originated from different mixing times, where foam could be partially destructed by extending the mixing time. The target thickness for all test specimen was 12.5 mm. Layer A of Samples 10 was 2.5 mm to 4.5 mm thick. The main components of all stucco slurries used in Samples 8 to 10 are listed in Table 4.

TABLE 4

| | Sample 8³ | Sample 8⁴ | Sample 9 | |
|---|---|---|---|---|
| | One layered | One layered | One layered | |
| | sample; | sample; | sample; | Sample 10⁵ |
| | surfactant | surfactant | synthetic polymer | Two-layered |
| | foam (foamed | foam (foamed | foam (foamed | sample |
| | to a density of | to a density of | to a density of | (layer A/ |
| | 135 g/L) | 135 g/L) | 100 g/L) | layer B) |
| W/S ratio¹ | 0.685 | 0.688 | 0.678 | 0.678/0.685- |
| | | | | 0.688 |
| Accelerator | 1.4 | 1.0 | 0.3 | 0.3/1.0- |
| [wt.-%]² | | | | 1.4 |
| Liquefier [wt.-%]² | 0.2 | 0.15 | 0.12 | 0.12/0.15- |
| | | | | 0.2 |
| Volume of | 500 | 312 | 340 | 340/312- |
| added foam [L] | | | | 500 |
| Surfactant | 0.01 | 0.01 | 0 | 0.01 (layer |
| active | | | | B only) |
| ingredients | | | | |
| [wt.-%]² | | | | |
| Synthetic | 0 | 0 | 0.5-0.75 | 0.5-0.75 |
| polymer solid | | | | (layer A |
| matter [wt.-%]² | | | | only)⁶ |

¹= water-to-stucco-ratio;
²based on weight of calcium sulfate binder;
³relative amounts for boards with a density of <800 kg/m³;
⁴relative amounts for boards with a density >800 kg/m³;
⁵relative amounts of layer A correspond Sample 9 and relative amounts of layer B correspond to Sample 8. Polyvinyl acetate was used as synthetic polymer foam for the test specimen of Samples 9 and 10;
⁶This corresponds to 0.3 wt.-% synthetic polymer solid matter based on the calcium sulfate binder of the entire test specimen.

TABLE 5
Samples 8

| Volumetric | Nail pull [N] ± standard |
|---|---|
| weight [kg/m³] | deviation of three measurements |
| 785** | 407 ± 11 |
| 786** | 389 ± 13 |
| 794** | 396 ± 10 |
| 842** | 417 ± 12 |

* relative amounts used to make boards correspond to Sample 8³ of Table 4;
**relative amounts used to make boards correspond to Sample8⁴ of Table 4

TABLE 6
Samples 9

| Volumetric | Nail pull [N] ± standard |
|---|---|
| weight [kg/m³] | deviation of three measurements |
| 798** | 425 ± 12 |
| 802** | 431 ± 18 |
| 839** | 464 ± 16 |

* relative amounts used to make Layer B correspond to Sample 8³ of Table 4;
**relative amounts used to make Layer B correspond to Sample 8⁴ of Table 4

TABLE 7
Samples 10

| Volumetric | Nail pull [N] ± standard |
|---|---|
| weight [kg/m³] | deviation of three measurements |
| 807*** | 454 ± 16 |
| 807*** | 480 ± 9 |
| 845*** | 468 ± 14 |

***Layer A had a thickness of 2.5 mm to 4.5 mm, Layer B had a thickness of 8 mm to 10 mm

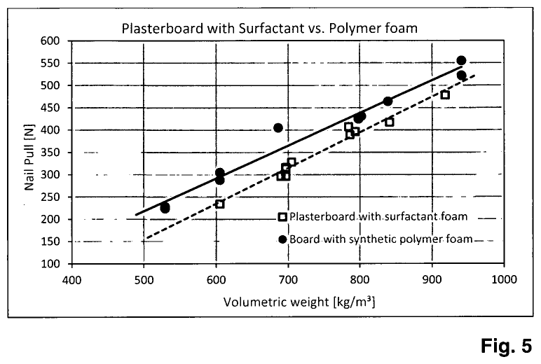

FIG. 5 shows that more strength was needed to extract a nail from a test specimen prepared with synthetic polymer foam than for a test specimen prepared with a surfactant foam at a comparable volumetric weight. In other words, samples produced only with surfactant foam achieve lower nail pull resistance values than samples produced only with synthetic polymer foam at comparable volumetric weights.

Tables 5 to 7 list the nail pull measurements of test specimen containing a surfactant foam (Table 5), test specimen containing a synthetic polymer foam (Table 6) and two-layered specimen (Table 7) for a representative range of volumetric weight. The comparison shows that a layer of only 2.5 mm to 4.5 mm of synthetic polymer foam is sufficient to achieve the nail pull results in the range of test specimen prepared entirely with synthetic polymer foam. The two-layered samples fall within or slightly above the correlation curve of the samples made with only synthetic polymer foam.

### LIST OF REFERENCE SIGNS

1 first foaming device for preparing synthetic polymer foam
2 second foaming device for preparing surfactant foam
3 first mixer
4 second mixer
5a, 50, 50a first discharging device for a first slurry comprising a synthetic polymer foam
6 second discharging device for a second stucco slurry comprising a surfactant foam
7, 7a liner
8 rotating roller
9 conveyor
10 setting belt
11 roller converyor
12 direction of travel to dryer
13 first conduit
14 second conduit
15, 15a layer A (formed from first slurry)
16 layer B (formed from second slurry)
17 guide roller

1. A plasterboard comprising at least two layers A and B of different composition, wherein layer A comprises a calcium sulfate binder and a synthetic polymer foam and the layer B comprises a calcium sulfate binder and a surfactant foam and wherein the at least one layer A is a surface layer.

2. The plasterboard according to claim 1, wherein the synthetic polymer foam comprises at least vinyl polymers and/or melamine polymers, particularly at least one selected from the group of polyvinyl acetate, polyvinyl alcohol, melamine formaldehyde, or combinations thereof.

3. The plasterboard according to claim 1, wherein the synthetic polymer foam of layer A comprises 0.2 to 5 wt.-%, preferably 0.4 to 3.5 wt.-%, most preferably 0.5 to 2.0 wt.-% of a synthetic polymer on a dry basis, relative to the calcium sulfate binder.

4. The plasterboard according to claim 1, wherein the layer A makes up 40% or less of the thickness of the plasterboard, preferably the layer A makes up 5% to 40% of the thickness of the plasterboard.

5. The plasterboard according to claim 1, wherein the density of the layers A and B differs by at most 100 kg/m³.

6. The plasterboard according to claim 1, wherein the layer A has a density in the range of 350 to 1200 kg/m³, preferably 350 to 700 kg/m³ and/or the layer B has a density in the range of from of 350 to 1200 kg/m³, preferably 350 to 700 kg/m³.

7. The plasterboard according to claim 1, wherein the layer A contains less surfactant foam than the layer B, preferably the layer A does not contain any surfactant foam.

8. A wall structure, comprising at least one plasterboard according to claim 1, wherein the plasterboard is mounted to at least one stud and wherein the plasterboard is positioned within the wall structure such that the at least one layer A of the plasterboard faces the interior of a room.

9. A method for the production of a plasterboard comprising the steps:
(i) preparing a synthetic polymer foam in a first foaming device and preparing a surfactant foam in a second foaming device,
(ii) preparing a calcium sulfate mixture comprising stucco, water and optional additives in a mixer,
(iii) admixing the synthetic polymer foam to a part of the mixture prepared in the mixer to form a first slurry for a layer A,
(iv) admixing the surfactant foam to another part of the mixture prepared in the mixer to form a second slurry for layer B,
(v) depositing the first slurry from a first discharging device onto a substrate to provide a layer A,
(vi) and depositing the second slurry from a second discharging device onto the first slurry forming layer A to provide a layer B.

10. The method according to claim 9, wherein in step (iii) additionally part of the surfactant foam is admixed to the mixture to form the first slurry for the layer A.

11. The method according to claim 10, wherein the amount of surfactant foam admixed to the first slurry for layer A is smaller than the amount of surfactant foam admixed to the second slurry for layer B, preferably the amount of surfactant foam is quantified as 0.01-1.0 wt.-% active ingredients relative to the calcium sulfate binder.

12. An apparatus for producing a plasterboard said apparatus comprising a first foaming device for producing a synthetic polymer foam and a second foaming device for producing a surfactant foam, and at least one mixer, a first and a second discharging device, wherein the first foaming device is fluidly interconnected to the first discharging device, and the second foaming device is fluidly interconnected to the second discharging device and wherein the first and the second discharging device are spaced apart spatially such that a first slurry from the first discharging device comprising the synthetic polymer foam is dispensed upstream of a second slurry of the second discharging device comprising the surfactant foam.

13. The apparatus according to claim 12, wherein the second foaming device is fluidly interconnected to the first discharging device and the second discharging device.

14. The apparatus according to claim 12, wherein the apparatus comprises a first and a second mixer, the first mixer having a first discharging device and the second mixer having a second discharging device and wherein the first foaming device is fluidly interconnected to the first discharging device via the first mixer and/or the second foaming device is fluidly interconnected to the second discharging device via the second mixer.

15. The apparatus according to claim 12, wherein the first foaming device is connected directly to the first discharging device and/or the second foaming device is connected directly to the second discharging device.
